(19) United States
(12) Patent Application Publication
(10) Pub. No.: US 2008/0109231 A1
(43) Pub. Date: May 8, 2008

(54) Mult card promotional item

(76) Inventor: Hugh Gene Loebner, New York, NY (US)

Correspondence Address: Hugh Leobner;c/o CROWN INDUSTRIES INC, 155 North Part St, East Orange, NJ, 07017, US

(21) Appl. No.: 11/593,207

(22) Filed: Nov. 6, 2006

(51) Int. Cl. G09F 1/00; G06Q 30/00

(52) U.S. Cl. 705/1; 40/124.01

(57) ABSTRACT

Four sided cards such as taught in U.S. Pat. No. 5,525,060, can be imprinted as business cards for use as promotional items. Such cards can be imprinted with information of an individual and also a logo or identifying information of a second party as well.

### BACKGROUND OF THE INVENTION

This invention relates to promotional items. Promotional items are useful items such as pens, knives, compasses, cups, etc., distributed by an entity (which we will call the “sponsor”) to promote the sponsor. Said items are imprinted or otherwise marked with the sponsor's name and, possibly, other identifying and contact information. The intention of the sponsor is that in the daily use of the item, the recipient will be reminded of the sponsor and, possibly, calls upon the sponsor for services or products.

This invention also relates to business cards. Business cards are thin, usually rectangular, sheets of cardboard, plastic, or wood imprinted with the identity of an individual (whom we will call the “named individual”).

Finally, this invention relates to four sided cards such as revealed in U.S. Pat. No. 5,525,060. This is a four sided flash card to be used for learning the Chinese language. Although U.S. Pat. No. 5,525,060 is concerned with the teaching of Chinese, other uses of a four sided card are possible. One such use is as a four sided business card, with each of the four sides carrying identifying information of the holder in a different writing system.

### SUMMARY OF THE PRESENT INVENTION

My invention comprises a four sided business card having identifying information of a named individual imprinted in more than one writing systems and also information of a sponsor imprinted on one or more sides of said card. As a result, the named individual will be reminded of the card's sponsor each time the holder distributes one of the cards to an individual, whom I will call the “recipient.”

An additional advantage of my invention is that the recipient also sees the identifying information of the sponsor, thereby making the recipient aware of the sponsor.

It is possible that the sponsor may make it a condition that the named individual be an active client or customer of the sponsor in order to receive such cards. A bank, for example, might distribute the four sided cards gratis to their commercial accounts. This might induce recipients of the card to become account holder of the bank also.

### DESCRIPTION OF THE DRAWINGS

FIGS. 1-4 show four sides of a hypothetical card in four writing systems; Chinese, Japanese, Korean, and the Roman alphabet. In the figures, the named individual is the inventor, and the sponsor is a hypothetical bank named “HLBC.” There are two interlocking cards 1 and 2. Each card has two sides A and B.

FIG. 1 is a view of side A of card 1 showing the cut line 3 as a dotted line from center to left edge. This side has Roman letters on the top and Japanese characters on the bottom.

FIG. 2 is a view of side A of card 2 showing cut line 3 as a dotted line from center to right edge. This side has Korean characters on the top and Roman letters on the bottom.

FIG. 3 is a view of side B of card 1 showing cut line 3 as a dotted line from center to left edge. This side has Chinese characters on the top and Korean characters on the bottom. FIG. 3 shows the hypothetical logo of the sponsor, in this case “HLBC.”

FIG. 4 is a view of side B of card 2 showing cut line 3 as a dotted line from center to right edge. This side has Japanese characters on the top and Chinese characters on the bottom.

### DESCRIPTION OF THE PREFERRED EMBODIMENT

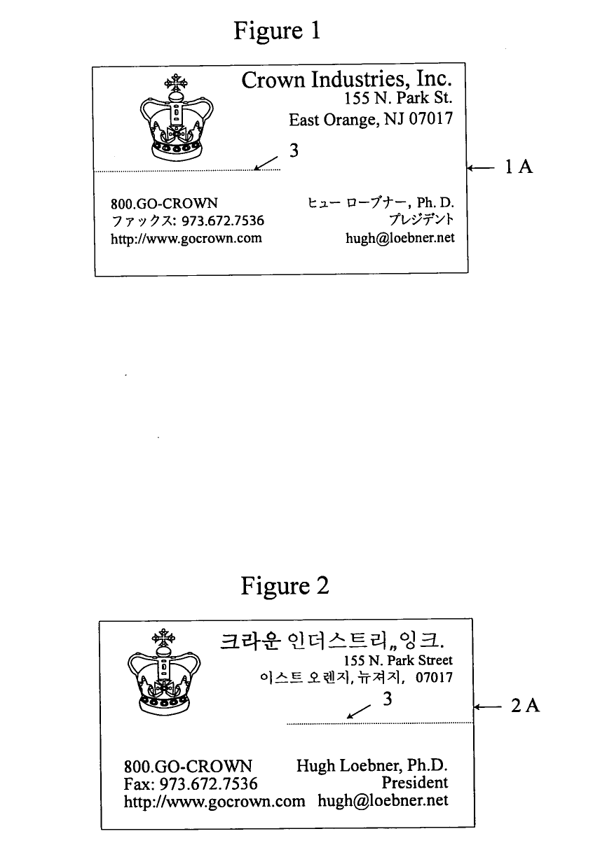

FIGS. 1-4 show the four sides of the two cards 1 and 2. The two cards interlock, as described in U.S. Pat. No. 5,525,060 to form one interlocking card of 4 sides. The top of card 2 slips behind the top of card 1. One can see from FIGS. 1 and 2 how the halves of the two cards, when interlocked, provide a single side with Roman letters apparently top and bottom.

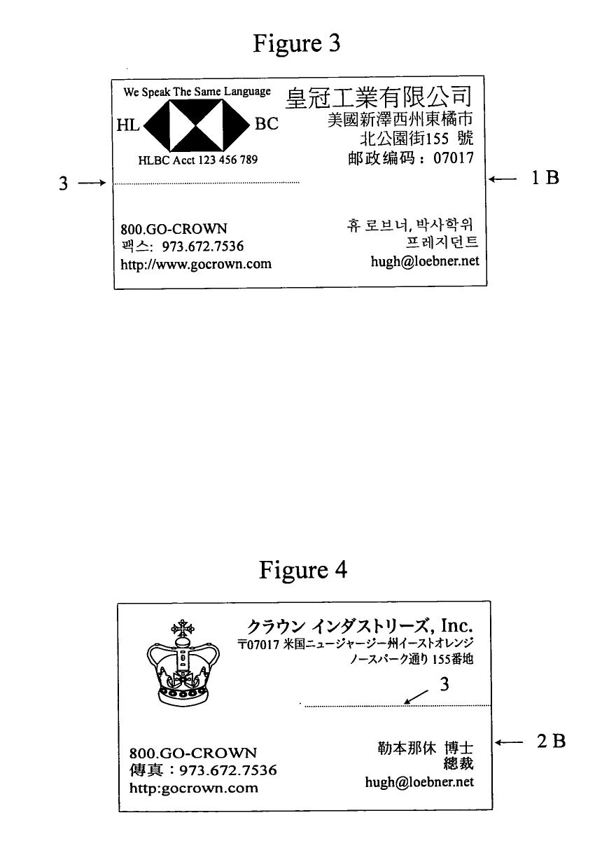

Inspection of FIG. 3 shows the logo of the hypothetical HLBC bank with its hypothetical slogan “We Speak Your Language.” This logo will appear on only one of the four sides of the multi-card promotional item. In this particular instance the logo will appear on the side opposite of the side inscribed with the Roman alphabet. Inspection of FIG. 3 shows that in this hypothetical instance, the card is inscribed with the named individuals account number. This could be associated with an internet website that, when the account number is keyed in, will show such information as the named individual wishes to be known. For example, keying in the hypothetical account number 123456789 might cause the website to display a picture of the individual and a credit limit.

The worker skilled in the art will understand that although the sponsor's logo is shown on only one side, it is possible for the logo to be imprinted on more than one of the faces of the card

I claim:

1. A multi-sided promotional business card, where said business card has four faces comprising two interlocking cards, said four faces being imprinted with identifying information of a named individual and identifying information of a sponsor.

2. A multi-card promotional business card according to claim 1, where said four faces are imprinted in four different writing systems.

3. A method of doing business comprising the manufacture and distribution of four sided business cards to active customers or clients of a sponsor, said cards having identifying information regarding the client or customer of said sponsor and identifying information of the sponsor.
